(19) United States
(12) Patent Application Publication
(10) Pub. No.: US 2015/0308679 A1
(43) Pub. Date: Oct. 29, 2015

(54) INTEGRATED SLUDGE DRYING AND ENERGY RECUPERATOR TRANSFORMER

(71) Applicants: Steven DELSON, Laguna Hills, CA (US); Lawrence E. DEES, JR., Aliso Viejo, CA (US)

(72) Inventors: Steven DELSON, Laguna Hills, CA (US); Lawrence E. DEES, JR., Aliso Viejo, CA (US)

(73) Assignee: GATE 5 ENERGY PARTNERS, INC., Aliso Viejo, CA (US)

(21) Appl. No.: 14/399,911

(22) PCT Filed: May 7, 2012
(86) PCT No.: PCT/US12/36831

§ 371 Date: Apr. 10, 2015

(51) Int. Cl. F23G 5/033; F23G 5/46; F23G 5/04; F23G 5/44; B02C 21/00; B02C 23/24

(52) U.S. Cl. CPC F23G 5/033; B02C 21/00; B02C 23/24; F23G 5/04; F23G 5/444; F23G 5/46; B02C 2201/063

(57) ABSTRACT

Integrated systems and processes are provided for drying and milling sludge and other natural waste using waste heat extracted from reheated gas through an air-air heat exchanger process. In one example, the sludge or natural waste may be dried into a powder using high-temperature gas to absorb moisture from the sludge, causing the high-temperature gas to become an at least partially saturated gas. The at least partially saturated gas may pass through a separator- scrubber cycle before a first portion is heated in an air-heater and then used to heat a second portion of the at least partially saturated gas in an air-air heat exchanger. The heat for the air-heater may be provided by a burner operable to burn the dried powder obtained from the sludge. The heated second portion of gas may be used to dry and mill the sludge and other natural waste.

### BACKGROUND

1. Field

This application relates generally to the integrated treatment of semi-solid waste materials containing organic solids and, more specifically, to processing municipal sewage sludge, agricultural waste, and other natural waste materials containing organic material (hereinafter referred to as “sludge”) for use as a source of energy.

2. Related Art

Many systems and processes have been developed to treat and dispose of sludge. For example, many systems and processes include removing moisture from the sludge and removing or stabilizing contaminants that may be harmful to the environment or that may pose substantial health risks if not dealt with properly when released into the environment. The moisture removed from the sludge is referred to herein as “waste water.” Many of these treatment systems and processes for removing moisture and contaminants from the sludge produce harmful byproducts of their own that require special handling for disposal.

The residual semi-solid material that results from waste and wastewater treatments, animal waste, and the like, is often referred to as “sludge.” In this application, the term “sludge” is also used to refer to agricultural food stock waste. Sludge, regardless of its origin, may be categorized based on the amount of treatment that it has undergone. For example, sludge that has not yet been decomposed by anaerobic bacteria is often referred to as “undigested sludge,” while sludge that has been decomposed by anaerobic bacteria is often referred to as “digested sludge.” Typically, undigested sludge and raw/fresh animal or food stock waste have higher calorific values, while digested sludge and aged animal or food stock waste typically has a lower calorific value in comparison.

More specifically, there are two main types of waste treatment methods anaerobic and aerobic. In anaerobic systems, microbes, in the absence of oxygen, are used to break down the raw waste or undigested sludge to form methane gas and other byproducts that may be used and must be properly disposed of. A typical length of time required to process waste using an anaerobic treatment system may be about twelve to twenty days.

A treatment plant utilizing an aerobic treatment process, however, may be able to treat raw, highly contaminated waste or undigested sludge in a single day. Typically, these systems utilize pre-treatment by anaerobic digestion, which may be carried out in an enclosed low-pressure vessel to break down the waste to allow methane gas to be extracted and prospectively used.

Sludge of all types, for example, undigested sludge, digested sludge, activated sludge, raw or fresh waste, aged waste, and the like (all of which are hereinafter referred to as “sludge”) includes more than 90% waste/moisture and will typically undergo a dewatering process in which a portion of the moisture may be removed and the liquid directed (i) back to and commingled with wastewater for treatment prior to disposal or discharge, or (ii) to holding lagoons where it will evaporate or migrate into the groundwater table. The dewatered sludge may be more efficiently processed since all types of sludge require processing before disposal.

Thus, systems and processes for the treating and disposing of sludge are desired.

### SUMMARY

In one exemplary embodiment, a system for processing dewatered sludge is provided. In some examples, the system may include a dryer, grinder, and/or mill (or combination thereof) operable to receive high-temperature gas, receive sludge, and reduce the moisture content of the sludge and to break the sludge into a dried powder in the presence of the high-temperature gas, wherein the high-temperature gas absorbs at least a portion of the moisture content of the sludge to become at least partially saturated gas. The system may further include a first separator operable to separate the dried powder from the at least partially saturated gas and a condenser operable to reduce a moisture content of the at least partially saturated gas by reducing the temperature below the dew point of the at least partially saturated gas. The system may further include a heater operable to heat a first portion of the reduced-moisture gas to form a heated first portion of gas, a heat exchanger operable to heat a second portion of the reduced-moisture gas using the heated first portion of gas to form a heated second portion of gas, a first fan operable to direct the heated second portion of gas to the dryer, grinder, and/or mill to be used as the high-temperature gas for reducing the moisture content of the sludge, and an output system operable to discharge the heated first portion of gas from the system. The system may further include a second fan operable to assist in the movement of the reduced-moisture gas.

In some examples, the sludge may include digested sludge, undigested sludge, fresh animal waste, aged animal waste, or agricultural food waste. In some examples, the heater may include a burner operable to burn a mixture of ambient air and at least a portion of the dried powder as fuel. The burner may be further operable to burn an oil or gas, separately or in combination with the dried powder fuel.

In some examples, the first condenser may be operable to receive water at a first temperature, the water to be used to reduce the temperature of the at least partially saturated gas, wherein the first condenser may be further operable to output the water at a second temperature that is higher than the first temperature. The water at the second temperature can be used for power or combined heat and power (“CHP”) generation or other purposes. In some examples, the system may include a storage tank operable to store the water after being used for power or CHP generation or other purposes, wherein the first condenser is coupled to receive water from the storage tank.

In some examples, the output system includes a second separator operable to separate at least a portion of ash contained in the heated first portion of gas from the heated first portion of gas, wherein the second separator is further operable to discharge the ash separated from the heated first portion of gas from the system. The output system may further include a second condenser operable to reduce a moisture content of the heated first portion of gas by reducing a temperature of the heated first portion of gas to form a reduced temperature gas. The output system may further include another fan operable to discharge the reduced temperature gas from the system. In some examples, the second condenser is operable to receive water at a first temperature, the water to be used to reduce the temperature of the heated first portion of gas, and wherein the second condenser is further operable to output the water at a second temperature that is higher than the first temperature. The water at the second temperature may be used for power or CHP generation or other purposes. In some examples, the system further includes a storage tank operable to store the water after being used for power or CHP generation or other purposes, wherein the second condenser is coupled to receive water from the storage tank.

In other exemplary embodiments, processes and computer-readable storage mediums are provided for processing sludge using the systems described above.

### BRIEF DESCRIPTION OF THE FIGURES

FIG. 1 illustrates a block diagram of an exemplary system for treating sludge.

FIG. 2 illustrates a block diagram of another exemplary system for treating sludge.

FIG. 3 illustrates an exemplary dual fuel burner and air-heater.

FIG. 4 illustrates an exemplary process for treating sludge.

FIG. 5 illustrates an exemplary computing system that may be used to control a sludge treatment system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

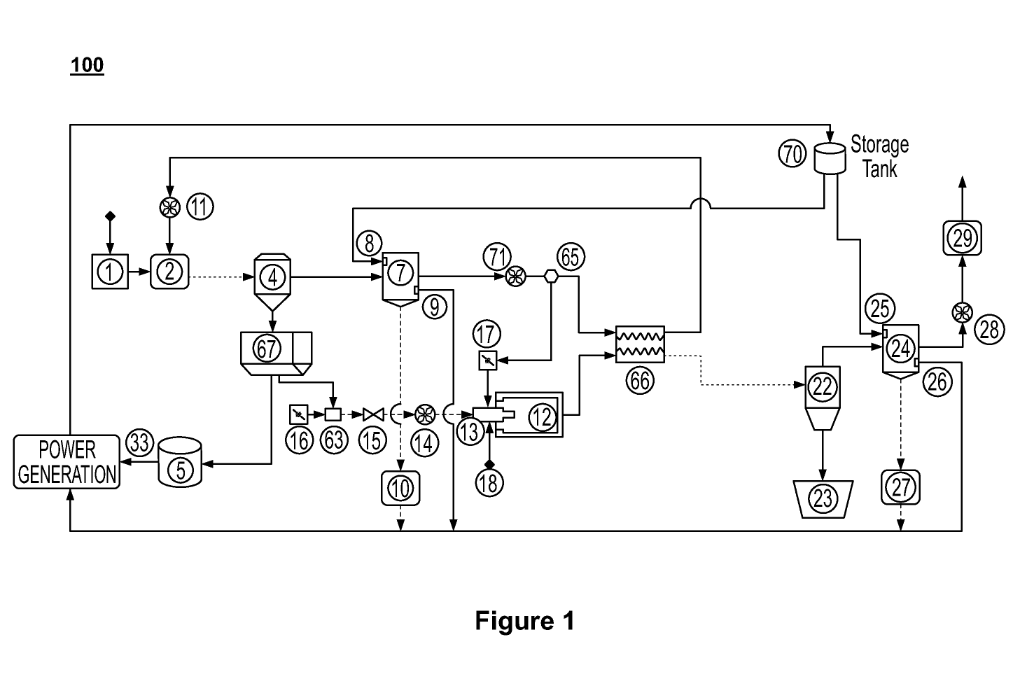

FIG. 1 illustrates a block diagram of an exemplary treatment system 100. As an overview, treatment system 100 may be used to treat sludge by converting waste/sludge into a powder having a high calorific value that is suitable for combustion in suspension or that may be used as a fertilizer. The treatment system 100 may be capable of processing various types of sludge, for example, digested sludge, undigested sludge, raw waste, fresh waste, aged waste, or combinations thereof. Treatment system 100 may also be used to treat agricultural food/crop wastes, which are herein included in the term “sludge.”

Treatment system 100 may include a storage unit 1 for holding sludge. In some examples, storage unit 1 may be used to store sludge that has been dewatered to have an approximate 15% to 60% solids content at ambient temperature. However, it should be appreciated that sludge having other content ratios may be used. Storage unit 1 may include any type of standard storage system suitable for storing sludge. The volume of storage unit 1 may depend on the location of treatment system 100 and “feed stock.” For instance, if treatment system 100 is situated at a municipal wastewater treatment plant or large-scale agricultural operation with an adequate continuous supply of sludge and onsite dewatering, storage unit 1 may be used only as a surge bin having a two to three hour sludge capacity since the treatment system 100 may be fed by the plant's sludge dewatering equipment. If, however, the treatment system 100 is at a treatment plant where the supply of sludge is not adequate for efficient operation of the system on a continuous basis, be it at a treatment plant, hog farm, cattle ranch, farm, or dairy with sludge being trucked in from other sites, the storage unit 1 may have a volume allowing storage of a 24-hour or more running capacity of wet sludge (e.g., between about 15%-60% solids). However, it should be appreciated that, irrespective of the examples cited, a storage unit 1 having any desired capacity may be used.

Treatment system 100 may further include a dryer, grinder, and/or mill (or combination thereof) 2 in which the moisture may be removed from the sludge that has been dewatered (either at the treatment site or offsite). The dryer, grinder, and/or mill 2 may also be used to process the sludge to a uniform, or at least substantially uniform, size. The dryer, grinder, and/or mill 2 may include a simplex or duplex design and may be configured to pulverize the sludge into a fine powder with a moisture content of less than about 10%. In some examples, dryer, grinder, and/or mill 2 may be operable to process on the order of 60 tons of wet sludge (15%-60% solids) over a 24-hour period by flash drying and milling or grinding the sludge to a fine powder with a moisture content of less than 10%, for example, 3%-5%. However, the treatment system may be of any greater or lesser capacity (size) and may reduce the moisture of the sludge to any amount.

It should be appreciated that the temperature of the process-gas at dryer, grinder, and/or mill 2 may vary depending on the specific application. The use of high-temperature gas in dryer, grinder, and/or mill 2 enables increased moisture pickup per unit weight of dry gas. As a result, the throughput of dryer, grinder, and/or mill 2 may be increased in spite of reduced heat input to the dryer, grinder, and/or mill 2. In some examples, the high-temperature gas can be received from air-air heat exchanger 66 via either system circulation fan 11 and/or process-air circulating fan 71 and can be at a temperature between 600° F. and 1,100° F. Due to the evaporative cooling that occurs within the dryer, grinder, and/or mill 2, the temperature of the gas stream may be reduced before exiting the dryer, grinder, and/or mill 2.

The sludge may be transferred from storage unit 1 to dryer, grinder, and/or mill 2 using any means that is capable of delivering an accurate, modulated supply of sludge to the dryer, grinder, and/or mill 2. For example, an auger capable of delivering previously dewatered, but otherwise wet, sludge may be used. The main feed auger may have a length sufficient to feed sludge from a storage unit 1, which may be located separate from, but adjacent to, the dryer, grinder, and/or mill 2. As mentioned above, in some examples the sludge may be pre-heated by process water using a water-to-sludge heat exchanger (not shown) before entering dryer, grinder, and/or mill 2.

Treatment system 100 may further include gas-solids separator 4 for separating particulate from the conveying gas received from dryer, grinder, and/or mill 2. Gas-solids separator 4 may be configured to receive the dried powder formed from the sludge and the gas stream carrying the sludge moisture from dryer, grinder, and/or mill 2. In some examples, the received mixture of power, air, and moisture may be received from dryer, grinder, and/or mill 2 at approximately 300° F. However, it should be appreciated that this temperature can vary depending on the system application or design. Gas-solids separator 4 may be configured to separate the dried powder from the at least partially saturated gas flow and deposit the separated powder in a splitter box 67. In some examples, gas-solids separator 4 may be made from a material capable of withstanding high gas temperatures and corrosive materials, such as stainless steel or other appropriate materials, and may be operable to remove at least 90% of the solids from the gas stream. Solids may be dropped via a rotary valve into the splitter box 67 or by any other means.

In some examples, gas-solids separator 4 may be a cellular-type separator. In these examples, the inlet to each individual cell may be fitted with a multiple blade spinner arranged to spin the gases and convey the particles to the outlet of the cell. The particles may, for example, be deposited into splitter box 67 while the clean conveying gas may pass to a condensing-type scrubber 7.

As mentioned above, once separated from the gas stream, the dried powder, which is now a biofuel, may be sent to splitter box 67. In some examples, splitter box 67 may be isolated from the separators by, for example, rotary valves. Additionally, as described in greater detail below, in some examples, splitter box 67 may include an auger that meters the dried powder to a mix box 63 where it may be combined with ambient air from primary air supply inlet 16 to be used by dual fuel burner 13 at a rate sufficient to provide enough heat for air-heater deodorizer 12. It should be appreciated that any rate may be used depending on the fuel mixture and other objectives of the system. Splitter box 67 may also include an output auger to deposit excess dried powder in fuel storage bin 5 for use in other systems or processes, for example, being output at fuel output 33 to be used as a fuel for power or CHP generation. In some examples, fuel storage bin 5 may include a safety system to prevent dust explosions. The safety system may reduce the possibility of dust explosions by, for example, injecting an inert gas, such as nitrogen or carbon dioxide, into fuel storage bin 5. Fuel storage bin 5 may be made of a material capable of withstanding high temperatures, such as stainless steel or other appropriate materials.

As mentioned above, treatment system 100 may further include a condensing-type scrubber 7 for removing moisture and leftover particulate from the at least partially saturated gas produced by gas-solids separator 4. In some examples, the at least partially saturated gas received from gas-solids separator 4 may be at a temperature above its dew point. The shell of condensing-type scrubber 7 may be made from a high-temperature and corrosion-tolerant material, such as stainless steel or other appropriate materials. Condensing-type scrubber 7 may receive the at least partially saturated gas leaving gas-solids separator 4, as well as water from an ambient-temperature water source 8, such as storage tank 70. The moisture in the at least partially saturated gas may be removed by lowering the temperature of this gas to below its dew point by, for example, use of ambient-temperature water, causing the moisture to condense out of the gas stream. As the moisture condenses into water, it may collect carry-over particulate remaining in the gas stream and carry the particulate to sludge condensate filter 10, where the particulate may be filtered from the condensate. After being filtered by sludge condensate filter 10, the filtered condensate can be used for power or CHP generation or other purposes. Additionally, after the ambient-temperature water from ambient-temperature water source 8 is used to cool the gas stream, the warmed water may be output at hot water outlet 9 and used separately or may be combined with the filtered condensate from sludge condensate filter 10 for power or CHP generation or other purposes.

In some examples, the at least partially saturated gas received from gas-solids separator 4 may be passed over a series of tubes that are cooled by the flow of water from ambient-temperature water source 8, causing the gas temperature to drop. As the cooled at least partially saturated gas temperature is lower than the dew point of the moisture, the moisture will condense out of this gas. In some examples, condensing-type scrubber 7 may include multiple layers of ripple-fin tube coils. These tubes may be cooled by water fed from an ambient water source 8 at a rate controlled to reduce the temperature of the incoming gas from gas-solids separator 4 to a temperature below its dew point.

Treatment system 100 may further include process-air circulation fan 71 for drawing the cooled gas or air from condensing-type scrubber 7 and circulating it to air diverter valve 65. In some examples, process-air circulation fan 71 may be made from temperature and corrosion-tolerant materials, such as stainless steel or other appropriate materials, and may circulate 100% of the weight of gas that passes through treatment system 100. In some examples, the gas may be drawn from condensing-type scrubber 7 by system process-air circulation fan 71 and may then be passed to air diverter valve 65. Process-air circulation fan 71 may include a speed control that may be adjusted based on the fuel used. While shown at the output of condensing-type scrubber 7, it should be appreciated that process-air circulating fan 71 may be located at the output of any of the dryer, grinder, and/or mill 2, gas-solids separator 4, or condensing-type scrubber 7.

Air diverter valve 65 can be configured to receive the circulated cooled gas from process-air circulation fan 71 and divert a portion of the cooled gas to air-air heat exchanger 66 and divert the remaining cooled gas to ambient air supply inlet 17. The amount of gas diverted to each of air-air heat exchanger 66 and ambient air supply inlet 17 depends on the requirements of air-heater deodorizer 12 and the overall system design of treatment system 100.

In some examples, the gas circulated by process-air circulation fan 71 and diverted to ambient air supply inlet 17 by air diverter valve 65 may be passed to the air-heater deodorizer 12 where it may be heated to a temperature and for a duration sufficient to deodorize and sterilize the process gas by dual fuel burner 13. In other examples, the gas may not be deodorized or sterilized. Air-heater deodorizer 12 may include two shells that form a jacket or incorporate refractory to contain the heat. The jacket may allow less insulation to be used on the outer surface of air-heater deodorizer 12, and also pre-heats incoming gas before entering the inner shell of air-heater deodorizer 12. Alternatively, an air-heater design (described in greater detail below) including ceramic or other refractory tiles may be used for the air-heating portions of the process.

In one example, gas from ambient air supply inlet 17 may enter the jacket of air-heater deodorizer 12 at the end opposite the dual fuel burner 13. The gas may then pass through the jacket wherein the gas may twist as it passes over the surface of the inner shell of air-heater deodorizer 12 towards the dual fuel burner 13 end of the jacket. This may cool the inner shell of air-heater deodorizer 12 while heating the circulating gas prior to entering the inner shell of air-heater deodorizer 12. The resultant lower-temperature of the inner shell of air-heater deodorizer 12 may not result in “clinker” formation. In some examples, the gas passing through the jacket may be heated to a temperature of about 300° F. prior to entering air-heater deodorizer 12. The gas may then pass into the inner shell of air-heater deodorizer 12 where it may be heated by the dual fuel burner 13 to a temperature sufficient for the length of the heating chamber so that the gas may be adequately heated for the specific treatment application.

Air-heater deodorizer 12 may alternatively be made from temperature and corrosion-tolerant materials, such as high-temperature stainless steel, ceramic lining, or other appropriate materials or combination of materials, and may operate at a through air velocity equal to several times the floating velocity of the ash particles to prevent particulate deposit in the heater (i.e., “clinker”). Using a high-temperature stainless steel, ceramic lining, or other similar material may allow a smooth internal shell to be presented to the gases and may limit the reduction in velocity over the shell that may occur when more conventional insulation is employed. Additionally, the diameter and length of the air-heater deodorizer 12 can be designed to keep the gas velocity greater than the floating velocity of the ash particles while not adversely affecting the flame velocity or temperature to overheat the flame-producing clinker from the ash.

As mentioned above, dual fuel burner 13 may be used to heat the gas in air-heater deodorizer 12. The dual fuel burner 13 may utilize any single or a combination of multiple fuels. The primary source may be the dried powder biofuel supplied from the splitter box 67. The secondary source may be a supplementary fuel source 18, such as gas (e.g., digester gas, natural gas, propane, and the like) or oil. The amount of fuel supplied to dual fuel burner 13 may be controlled to maintain a desired outlet temperature for dryer, grinder, and/or mill 2, or alternately as may be required for the air-heater deodorizer 12. Additionally, the dual fuel burner 13 may be able to supply 100% of the heat required on either biofuel or supplementary fuel alone. In some examples, dual fuel burner 13 may include a separate ignition system (not shown), which may be fired by either powdered biofuel, oil, or gas. In some examples, the separate ignition burner may be used to maintain the system temperature in a stand-by mode during times when sludge is not being processed.

The dual fuel burner 13 may be supplied with biofuel and air from a combustion supply fan 14. In some examples, combustion supply fan 14 draws ambient air from the atmosphere through a primary air supply inlet 16. In some examples, the ambient air from primary air supply inlet 16 may be mixed with the dried powder biofuel at mix box 63 before entering the fuel venturi 15. The fuel venturi 15 may include a venturi valve arranged to further mix the ambient air from primary air supply inlet 16 with dried power from splitter box 67. Primary air supply inlet 16 may include an air-to-air heat exchanger system (not shown), as well as a filter and grill fitted with an integral adjustable baffle to control downstream pressure and minimize dust drawn to dual fuel burner 13. The combustion supply fan 14 may include a dust handling fan and may supply the dual fuel burner 13 with the mix of ambient air and the dried powder metered from the splitter box 67. In some examples, combustion supply fan 14 may include a variable speed drive to control the airflow to dual fuel burner 13 or, alternately, ambient air from the primary air supply inlet 16 may provide all of the air to the dual fuel burner 13.

In some examples, the weight of ambient air that enters dual fuel burner 13 through primary air supply inlet 16 may be equal to approximately three to ten times that the weight of process-air from diverter valve 65 entering dual fuel burner 13.

Treatment system 100 may further include air-air heat exchanger 66 for drawing heat from the heated gas from air-heater deodorizer 12 to heat air not diverted to the dual fuel burner 13 by diverter valve 65. Air-air heat exchanger 66 can include pipe coils and fins configured to facilitate the transfer of heat in the deodorized and sterilized air from the air-heater deodorizer 12 to the gas from the diverter value 65 to output gas at a temperature sufficient to remove the appropriate amount of moisture from the sludge at dryer, grinder, and/or mill 2. The gas received from diverter valve 65 and heated by air-air heat exchanger 66 can be recirculated back to dryer, grinder, and/or mill 2 by system circulation fan 11 and/or process-air circulation fan 71. The recirculated gas can be used by dryer, grinder, and/or mill 2 to reduce the moisture content of the sludge, as described above. While FIG. 1 shows system circulation fan 11 coupled between dryer, grinder and/or mill 2 and air-air heat exchanger 66, in another example, system circulation fan 11 can be positioned between diverter valve 65 and air-air heat exchanger 66. In yet another example, treatment system 100 may not include system circulation fan 11 and process-air circulation fan 71 can be sized appropriately to move the gas through treatment system 100 without the aid of system circulation fan 11.

Treatment system 100 may further include ash separator 22 for receiving the gas heated by air-heater deodorizer 12 and later cooled by air-air heat exchanger 66. The received cooled gas from air-air heat exchanger 66 may include ash from air-heater deodorizer 12 along with some residual moisture from air-air heat exchanger 66. Ash separator 22 may be used to remove ash from the output of air-air heat exchanger 66 and deposit the removed ash in ash storage 23. In some examples, ash separator 22 may include a Stairmand-type high-efficiency cyclone to clean the gas received from air-air heat exchanger 66. Specifically, one or more cyclones, each made from temperature and corrosion-resistant materials (e.g., stainless steel), may be used to separate the particles from the conveying gas output by air-air heat exchanger 66 and may discharge the solids ash storage 23. The cleaned gas may then be sent to terminal condensing scrubber 24. While the above examples were described using Stairmand-type cyclones, other cyclone separators, a baghouse, or other gas solids separators capable of functioning effectively and safely in the operating temperatures may be used to clean the gas output from the air-air heat exchanger 66.

The gas exiting ash separator 22 can be directed to terminal condensing scrubber 24. Terminal condensing scrubber 24 may be similar or identical to condensing-type scrubber 7 and may be used to condense moisture out of the gas received from ash separator 22. For instance, terminal condensing scrubber 24 may direct the gas received from ash separator 22 over a series of tubes that are cooled by the flow of water from ambient-temperature water source 25, such as storage tank 70, causing the gas temperature to drop below its dew point. As the moisture condenses into water at condensing scrubber 24, it may collect carry-over particulate remaining in the gas stream and carry the particulate to condensate filter 27, where the particulate may be filtered from the condensate. After being filtered by condensate filter 27, the filtered condensate can be used separately or combined with the warmed ambient-temperature water output at hot water outlet 9 and the filtered condensate from sludge condensate filter 10 for power or CHP generation or other purposes. Additionally, in some examples, the warmed ambient-temperature water from ambient-temperature water source 25 may exit terminal condensing scrubber 24 through hot water outlet 26 where it can be used separately or combined with the warmed ambient-temperature water output at hot water outlet 9, the filtered condensate from sludge condensate filter 10, and the filtered condensate from condensate filter 27 for power or CHP generation or other purposes.

After being used for power or CHP generation or other purposes, the water from hot water outlet 9, sludge condensate filter 10, hot water outlet 26, and condensate filter 27 can be stored in storage tank 70 where it can be held until needed as ambient-temperature water source 8 and/or 25, as described above. In some examples, storage tank 70 may be constructed out of steel or plastic and be sized to provide a continuous supply of ambient-temperature water for treatment system 100.

Treatment system 100 may further include a terminal fan 28 for drawing the surplus gas through the ash separator 22 and terminal condensing scrubber 24. The output of terminal fan 28 may be discharged from the system through the discharge stack to the air quality control 29 and then to the atmosphere.

In some examples, the weight of gas that enters treatment system 100 from the atmosphere through primary air supply inlets 16 may be equal to the weight of gas that is removed from the system though the discharge stack to the air quality control 29 and then to the atmosphere. As a result, a constant weight of gas circulating through the system may be maintained.

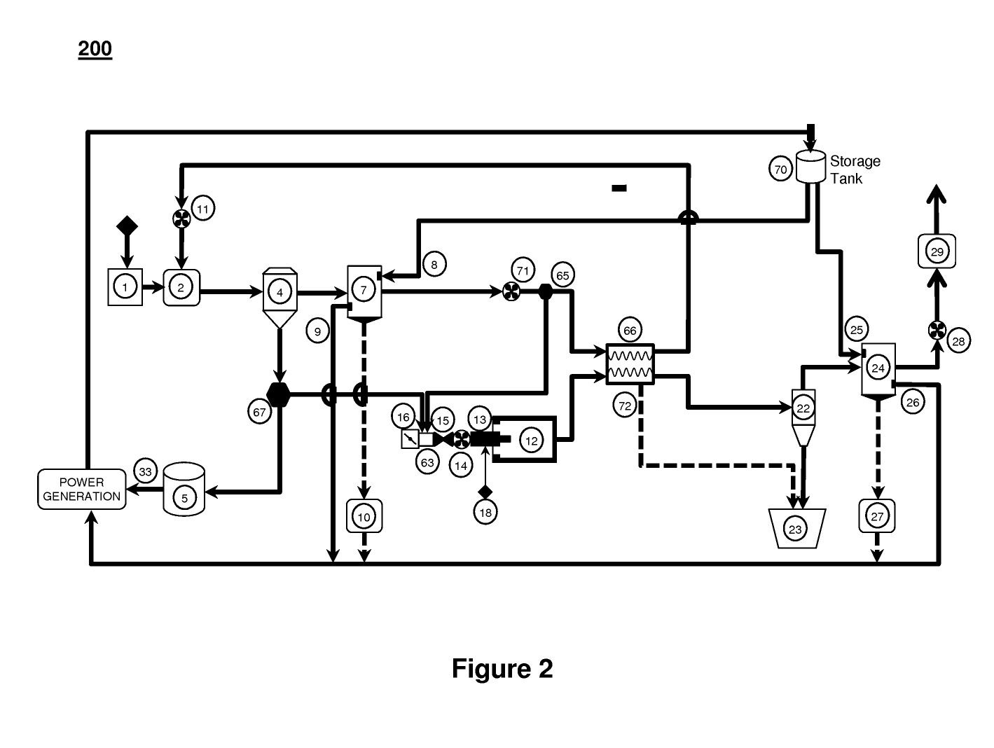

FIG. 2 illustrates a block diagram of another exemplary treatment system 200. Treatment system 200 may be similar to treatment system 100, with the differences discussed in greater detail below. Reference numbers for components of treatment system 200 that are the same as those used for components in treatment system 100 indicate that a similar component may be used in treatment system 200.

Unlike system 100, system 200 may not include ambient air supply inlet 17 and the output of diverter valve 65 may instead be coupled to mix box 63 where the portion of gas diverted to mix box 63 can be mixed with ambient air from primary air supply inlet 16 and dried powder from splitter box 67. The amount of gas diverted to each of air-air heat exchanger 66 and mix box 63 by diverter valve 65 depends on the requirements of air-heater deodorizer 12 and the overall system design of treatment system 200.

Since the air discharging from the air-air heat exchanger 66 may carry the combusted biofuel and other inorganic materials reaching the dual fuel burner 13, system 200 may further include ash outlet 72 for conveying sterilized air and ash between an output of air-air heat exchanger 66 and an input of ash storage 23. Ash outlet 72 may be to discharge a portion of the ash directly to the ash storage bin 23 without having the ash pass through the cooling coils.

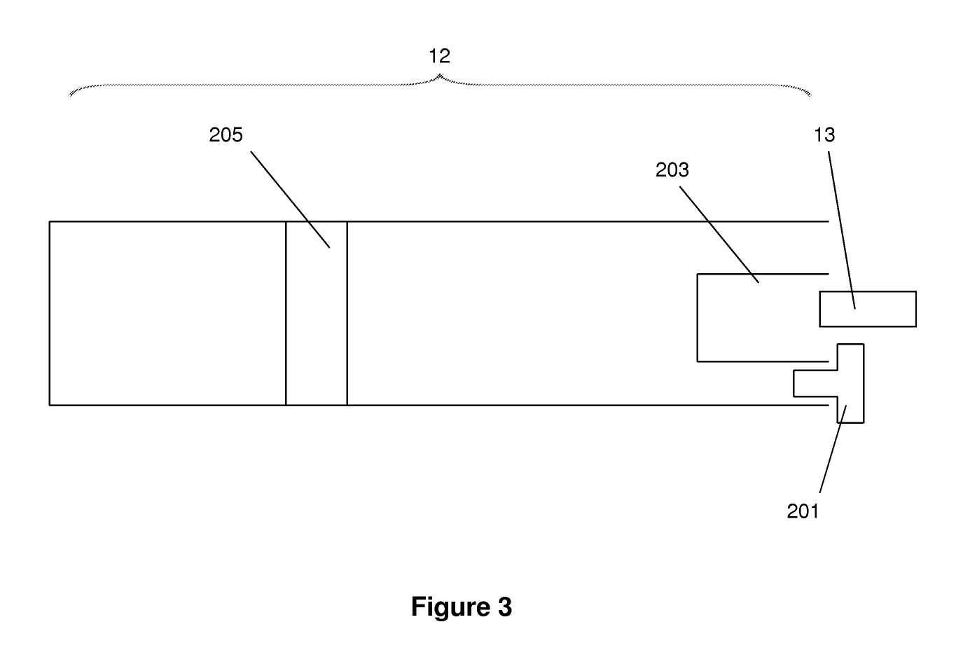

FIG. 3 illustrates an exemplary dual fuel burner and air-heater that may be used as dual fuel burner 13 and air-heater deodorizer 12 in the examples provided above. Ducted gas from process-air circulation fan 71 may be brought into dual fuel burner 13 through wye 201. A portion of the ducted air may enter dual fuel burner 13 and may be controlled by an actuated damper. The remainder of the ducted air may be directed down the other branch of wye 201 into a collection box for even distribution around combustion chamber 203. In this way, the amount of air and fuel into dual fuel burner 13 can be controlled more precisely to complete combustion without having to control combustion with additional air.

In some examples, the inside of combustion chamber 203 may be lined with refractory tiles or another insulating material. Additionally, the combustion chamber 203 may be centered inside the air-heater shell. Air-heater deodorizer 12 may further include a bellows-type expansion joint having rods externally preventing the shell from expanding beyond material tolerances and keeping expansion to a tolerable level.

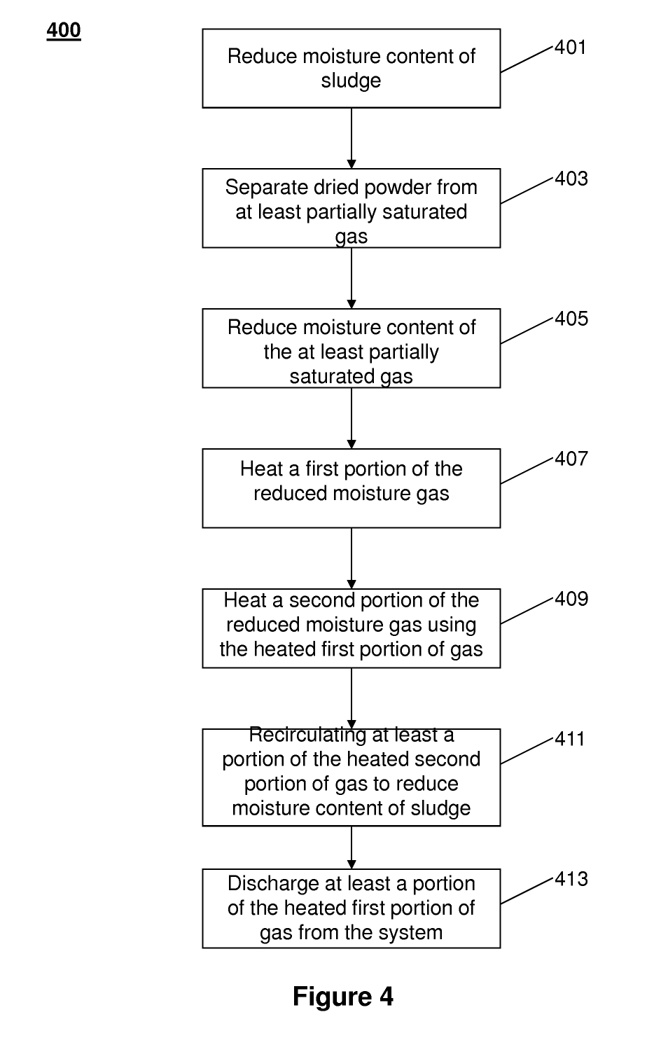

FIG. 4 illustrates an exemplary process 400 for treating sludge. In some examples, process 400 can be performed using a treatment system similar or identical to treatment system 100 or 200. At block 401, the moisture content of the dewatered sludge may be reduced to form at least partially saturated gas. In some examples, this may be done using dryer, grinder, and/or mill 2 as described above. For instance, sludge may be broken up in the presence of hot air to form a powder having a moisture content of less than about 10%. The hot air may absorb at least a portion of the moisture contained in the sludge. In some examples, the dewatered sludge may be heated at the dryer, grinder, and/or mill 2 using, for example, heated gas received from the air-air heater 66 via system circulation fan 11 and/or process-air circulation fan 71.

At block 403, the dried powder may be separated from the at least partially saturated gas generated at block 401. In some examples, this may be done using gas-solids separator 4 as described above. For instance, gas-solids separator 4 may be operable to separate the powder from the at least partially saturated gas generated by dryer, grinder, and/or mill 2 and deposit the separated powder into a splitter box 67. In some examples, gas-solids separator 4 may be a cellular type separator and may include one or more Stairmand-type cyclones or other satisfactory equipment to clean the received at least partially saturated gas.

At block 405, the moisture content of the at least partially saturated gas may be reduced by reducing the temperature of the at least partially saturated gas to below its dew point to form a reduced-moisture gas and hot water. In some examples, this may be done using condensing-type scrubber 7 as described above. For instance, the at least partially saturated gas may be passed through a series of tubes that are cooled by ambient-temperature water received from a water source 8, such as storage tank 70. As the at least partially saturated gas cools below the dew point of the gas moisture, at least a portion of the moisture condenses out of the gas. As the moisture condenses into water, it may collect carry-over particulate remaining from the gas stream and carry the particulate to sludge condensate filter 10, where the particulate may be filtered from the condensate. After being filtered by sludge condensate filter 10, the filtered condensate can be used for power or CHP generation, other purposes, or stored in storage tank 70 for use in the system. Additionally, after the ambient-temperature water from ambient-temperature water source 8 is used to cool the gas stream, the ambient-temperature water may be warmed to a higher temperature and output at hot water outlet 9 and used separately or may be combined with the filtered condensate from sludge condensate filter 10 for power or CHP generation or other purposes.

At block 407, a first portion of the reduced-moisture gas generated at block 405 may be heated to form a heated first portion of gas. In some examples, the first portion of the reduced-moisture gas generated at block 405 may be conveyed to a burner system “chain” including elements 13, 14, 15, 16, and 63 and heated to deodorize and sterilize it in the air-heater deodorizer 12. The dual fuel burner 13 may combust, for example, the powdered biofuel dried at dryer, grinder, and/or mill 2, gas or oil from a supplementary fuel source 18, or combinations thereof.

At block 409, a second portion of the reduced-moisture gas generated at block 405 may be heated using the heated first portion of gas produced at block 407 to form a heated second portion of gas. In some examples, the heated first portion of gas generated at block 407 may be cooled through air-air heat exchanger 66 to convey a portion of its heat to heat the second portion of the reduced-moisture gas generated at block 405.

At block 411, at least a portion of the heated second portion of gas may be recirculated to the dryer, grinder, and/or mill 2. This recirculated gas may be used by dryer, grinder, and/or mill 2 as the hot air used to reduce the moisture content of the sludge. A fan, such as system circulation fan 11, may be used to draw the heated gas from air-air heat exchanger 66 and direct this heated gas to dryer, grinder, and/or mill 2, as described above. Alternatively or in addition, a fan, such as process-air circulation fan 71, may be used to push a portion of the reduced-moisture gas to the dryer, grinder, and/or mill 2 after it is heated in the air-air heat exchanger 66. The gas heated at block 409 can then be used to reduce the moisture content of sludge at block 401 using dryer, grinder, and/or mill 2.

At block 413, at least a portion of the heated first portion of gas, which may have been at least partially cooled through air-air heat exchanger 66, may be discharged from the system. In some examples, this may be done using an output system including ash separator 22, ash storage 23, terminal condensing scrubber 24, condensate filter 27, terminal fan 28, and air quality control 29, as described above. In some examples, at least a portion of the ash contained in the heated first portion of gas generated at block 407 may be removed using ash separators 22 and condensing scrubber 24, as described above. In particular, ash separators 22 may have a design similar to that of condensing-type scrubber 7 and may be operable to remove at least a portion of the ash contained in the heated first portion of gas generated at block 407 (which was subsequently reduced in temperature by air-air heat exchanger 66) and conveyed to ash storage 23. In some examples, the filtered condensate and the heated ambient water from condensing scrubber 24 can be used for power or CHP generation or other purposes. Terminal fan 28 may then be used to discharge the final gas from the system though the discharge stack to the air quality control 29 and then to the atmosphere.

It should be appreciated that while the blocks of process 400 are provided in a particular order, the blocks can be performed in any order and process 400 can include all or a portion of the blocks listed above.

Those skilled in the art will recognize that the operations of some variations may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art, to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the apparatus and methods described herein.

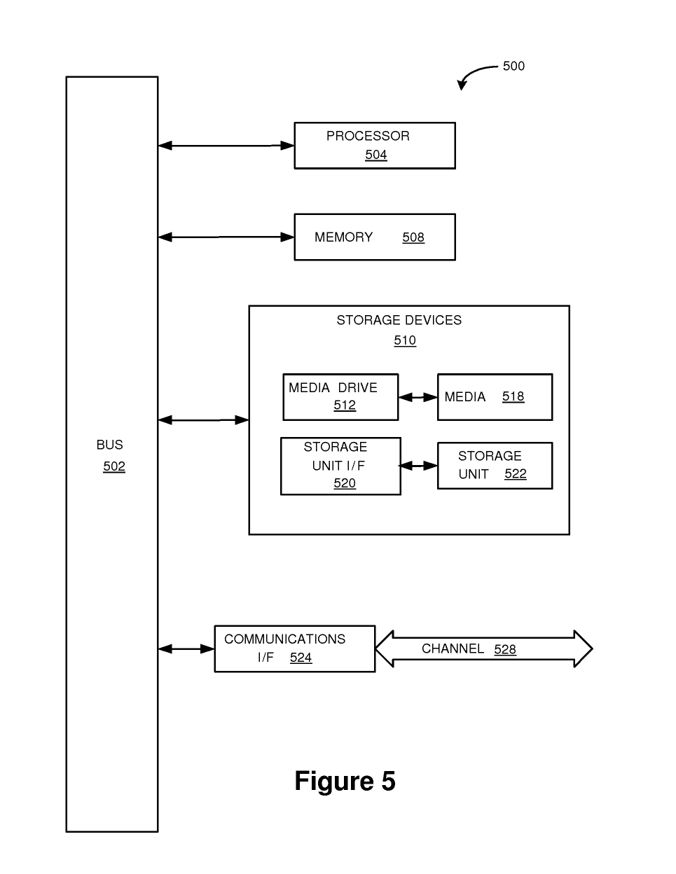

FIG. 5 illustrates a typical computing system 500 that may be employed to carry out processing functionality in some variations of the process. For instance, computer system 500 may be used to control one or more elements of the exemplary treatment systems described above. Those skilled in the relevant art will also recognize how to implement the apparatus and methods described herein using other computer systems or architectures. Computing system 500 may represent, for example, a desktop, laptop, or notebook computer, hand-held computing device (PDA, mobile phone, tablet, etc.), mainframe, supercomputer, server, client, or any other type of special or general purpose computing device as may be desirable or appropriate for a given application or environment. Computing system 500 can include one or more processors, such as a processor 504. Processor 504 can be implemented using a general or special purpose processing engine such as, for example, a programmable logic controller, a microprocessor, controller, or other control logic. In this example, processor 504 is connected to a bus 502 or other communication medium.

Computing system 500 can also include a main memory 508, preferably random access memory (RAM) or other dynamic memory, for storing information and instructions to be executed by processor 504. Main memory 508 also may be used for storing temporary variables or other intermediate information during execution of instructions to be executed by processor 504. Computing system 500 may likewise include a read-only memory (“ROM”) or other static storage device coupled to bus 502 for storing static information and instructions for processor 504.

The computing system 500 may also include information storage mechanism 510, which may include, for example, a media drive 512 and a removable storage interface 520. The media drive 512 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 518, may include, for example, a hard disk, floppy disk, magnetic tape, optical disk, CD or DVD, or other fixed or removable medium that is read by and written to media drive 512. As these examples illustrate, the storage media 518 may include a computer-readable storage medium having stored therein particular computer software or data.

In some variations, information storage mechanism 510 may include other similar instrumentalities for allowing computer programs or other instructions or data to be loaded into computing system 500. Such instrumentalities may include, for example, a removable storage unit 522 and an interface 520, such as a program cartridge and cartridge interface, a removable memory (for example, a flash memory or other removable memory module) and memory slot, and other removable storage units 522 and interfaces 520 that allow software and data to be transferred from the removable storage unit 522 to computing system 500.

In some variations, computing system 500 can also include a communications interface 524. Communications interface 524 can be used to allow software and data to be transferred between computing system 500 and external devices. Non-limiting examples of communications interface 524 can include a modem, a network interface (such as an Ethernet or other NIC card), a communications port (such as for example, a USB port), a PCMCIA slot and card, a PCI interface, etc. Software and data transferred via communications interface 524 are in the form of signals which can be electronic, electromagnetic, optical, or other signals capable of being received by communications interface 524. These signals are provided to communications interface 524 via a channel 528. This channel 528 may carry signals (e.g., signals to and from sensors or controllers) and may be implemented using a wireless medium, wire or cable, fiber optics, or other communications medium. Some examples of a channel include a phone line, a cellular phone link, an RF link, a network interface, a local or wide area network, and other communications channels.

The terms “computer program product” and “computer-readable storage medium” may be used generally to refer to non-transitory storage media, such as, for example, memory 508, storage device 518, or storage unit 522. These and other forms of computer-readable storage media may be involved in providing one or more sequences of one or more instructions to processor 504 for execution. Such instructions, generally referred to as “computer program code” (which may be grouped in the form of computer programs or other groupings), when executed, enable the computing system 500 to perform features or functions of embodiments of the apparatus and methods, described herein.

In some variations where the elements are implemented using software, the software may be stored in a computer-readable storage medium and loaded into computing system 500 using, for example, removable storage drive 512 or communications interface 524. The control logic (in this example, software instructions or computer program code), when executed by the processor 504, causes the processor 504 to perform the functions of the apparatus and methods, described herein.

It will be appreciated that, for clarity purposes, the above description has described embodiments of the apparatus and methods described herein with reference to different functional units and processors. However, it will be apparent that any suitable distribution of functionality between different functional units, processors, or domains may be used without detracting from the apparatus and methods described herein. For example, functionality illustrated to be performed by separate processors or controllers may be performed by the same processor or controller. Hence, references to specific functional units are only to be seen as references to suitable means for providing the described functionality, rather than as indicative of a strict logical or physical structure or organization.

While specific components and configurations are provided above, it will be appreciated by one of ordinary skill in the art that other components variations may be used. Additionally, although a feature may appear to be described in connection with a particular embodiment, one skilled in the art would recognize that various features of the described embodiments may be combined. Moreover, aspects described in connection with an embodiment may stand alone.

Furthermore, although individually listed, a plurality of means, elements, or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A system for processing dewatered sludge, the system comprising:
at least one of a dryer, grinder, or mill operable to:
receive high-temperature gas;
receive sludge; and
reduce a moisture content of the sludge by breaking the sludge into a dried powder in the presence of the high-temperature gas, wherein the high-temperature gas absorbs at least a portion of the moisture content of the sludge to form at least partially saturated gas;
a first separator operable to separate the dried powder from the at least partially saturated gas;
a first condenser operable to reduce a moisture content of the at least partially saturated gas by reducing a temperature of the at least partially saturated gas to form a reduced-moisture gas;
a heater operable to heat a first portion of the reduced-moisture gas to form a heated first portion of gas;
a heat exchanger operable to heat a second portion of the reduced-moisture gas using the heated first portion of gas to form a heated second portion of gas;
a first fan operable to direct the heated second portion of gas to the at least one of the dryer, grinder, or mill to be used as the high-temperature gas for reducing the moisture content of the sludge; and
an output system operable to discharge at least a portion of the heated first portion of gas from the system.

2. The system of claim 1, wherein the sludge comprises at least one of digested sludge, undigested sludge, fresh animal waste, aged animal waste, or agricultural food waste.

3. The system of claim 1, wherein the heater comprises a burner operable to burn a mixture of ambient air and at least a portion of the dried powder.

4. The system of claim 3, wherein the burner is further operable to burn a gas or oil.

5. The system of claim 1, wherein the first condenser is operable to receive water at a first temperature, the water to be used to reduce the temperature of the at least partially saturated gas, and wherein the first condenser is further operable to output the water at a second temperature that is higher than the first temperature.

6. The system of claim 5, wherein the water at the second temperature is used for power or combined heat and power generation.

7. The system of claim 6, further comprising a storage tank operable to store the water after being used for power or combined heat and power generation, wherein the first condenser is coupled to receive water from the storage tank.

8. The system of claim 1, wherein the output system comprises:
a second separator operable to separate at least a portion of ash contained in the heated first portion of gas from the heated first portion of gas, wherein the second separator is further operable to discharge the ash separated from the heated first portion of gas from the system;
a second condenser operable to reduce a moisture content of the heated first portion of gas by reducing a temperature of the heated first portion of gas to form a reduced moisture gas; and
a second fan operable to discharge the reduced moisture gas from the system.

9. The system of claim 8, wherein the second condenser is operable to receive water at a first temperature, the water to be used to reduce the temperature of the heated first portion of gas, and wherein the second condenser is further operable to output the water at a second temperature that is higher than the first temperature.

10. The system of claim 9, wherein the water at the second temperature is used for power or combined heat and power generation.

11. The system of claim 10, further comprising a storage tank operable to store the water, wherein the second condenser is coupled to receive water from the storage tank.

12. A method for processing dewatered sludge in a treatment system, the method comprising:
reducing, in at least one of a dryer, mill, or grinder, a moisture content of a dewatered sludge by breaking the dewatered sludge into a dried powder in the presence of high-temperature gas, wherein the high-temperature gas absorbs at least a portion of the moisture content of the dewatered sludge to form at least partially saturated gas;
separating the dried powder from the at least partially saturated gas;
reducing a moisture content of the at least partially saturated gas by reducing a temperature of the at least partially saturated gas to form a reduced-moisture gas;
heating a first portion of the reduced-moisture gas to generate a heated first portion of gas;
heating a second portion of the reduced-moisture gas using the heated first portion of gas to generate a heated second portion of gas; and
recirculating at least a portion of the heated second portion of gas by directing the at least a portion of the heated second portion of gas to the at least one of the dryer, mill, or grinder, wherein the at least a portion of the heated second portion of gas is to be used in the at least one of the dryer, mill, or grinder as the high-temperature gas.

13. The method of claim 12, wherein the second portion of the reduced-moisture gas is heated using an air-air heat exchanger.

14. The method of claim 12, wherein separating the dried powder from the at least partially saturated gas is performed using a first gas-solids separator.

15. The method of claim 12, wherein heating the first portion of the reduced-moisture gas is performed using a burner operable to combust with a mixture of ambient air, heated process air, and at least a portion of the dried powder.

16. The method of claim 15, wherein the burner is further operable to burn a gas or oil.

17. The method of claim 12, wherein reducing the moisture content of the at least partially saturated gas is performed using a first condenser operable to receive water at a first temperature, the water to be used to reduce the temperature of the at least partially saturated gas, and wherein the first condenser is further operable to output the water at a second temperature that is higher than the first temperature.

18. The method of claim 17 further comprising using the water at the second temperature for power or combined heat and power generation.

19. The method of claim 12 further comprising discharging the heated first portion of gas from the system.

20. The method of claim 12, wherein discharging the first portion of gas comprises:
separating, using a second separator, at least a portion of ash contained in the heated first portion of gas from the heated first portion of gas;
reducing, using a second condenser, a moisture content of the heated first portion of gas by reducing a temperature of the heated first portion of gas to form a reduced moisture gas; and
discharging the reduced moisture gas and the separated ash from the system.

21. The method of claim 20, wherein reducing the moisture content of the heated first portion of gas is performed using a second condenser operable to receive water at a first temperature, the water to be used to reduce the temperature of the heated first portion of gas, and wherein the second condenser is further operable to output the water at a second temperature that is higher than the first temperature.

22. The method of claim 21 further comprising using the water at the second temperature for power or combined heat and power generation.
